(19) United States
(12) Patent Application Publication
(10) Pub. No.: US 2005/0204037 A1
(43) Pub. Date: Sep. 15, 2005

(54) Method and apparatus for content identification/control

(76) Inventor: Kenneth L. Levy, Stevenson, WA (US)

Correspondence Address: DIGIMARC CORPORATION, 9405 SW GEMINI DRIVE, BEAVERTON, OR, 97008, US

(21) Appl. No.: 10/797,920

(22) Filed: Mar. 9, 2004

(51) Int. Cl. G06F 15/173; G06F 11/30; G06F 12/14

(52) U.S. Cl. 709/225; 709/224; 713/201

(57) ABSTRACT

Consumers should be allowed to easily access content within their home, and share between their homes if allowed based upon geographical constraints, but not allow the content to be illegitimately shared between domains of different ownership. An efficient solution is to add intelligence information to the header of the IP packets that enables the firewall to determine if that packet, without requiring other packets from the same content and without touching the data within the packet, can be forwarded and/or if billing charges should apply.

### FIELD OF THE INVENTION

The present invention relates to identification and control of electronic content (e.g., audio, video, etc.).

### BACKGROUND AND SUMMARY OF THE INVENTION

Proprietors of digital content do not want certain content freely shared. If consumers are able to freely re-distribute content, the proprietors must recoup the costs of production from the paying consumers, while other consumers get a free ride. Those who pay, pay extra.

On the other hand, consumers rightly feel that a purchased DVD should play both on the consumer's dedicated DVD player as well as on the consumer's personal computer. Accordingly, any copy management system should not prevent use of content on different devices owned by the same consumer.

Various technologies have been proposed to address this problem. However, they suffer a variety of shortcomings.

One technology uses the concept of “authorized domains.” Each device in the consumer's home (e.g., PC, DVD player, DVD recorder, set-top box, digital TV, MP3 appliance) shares an identifier that is associated with that consumer. Content distributed to the consumer is encrypted by reference to this identifier, and is associated with a set of rules governing permitted usage. Since each device in the consumer's home has the same ID, each can decrypt the content and make use of it (provided the usage rules are not violated). If content is transferred from one device to another—regardless of the transmission mechanism—the second device will be able to use it just as did the first—provided both share the same identifier. The “authorized domain” is thus all devices owned by the consumer which share the same identifier. This approach effectively locks the content to a particular authorized domain.

A problem arises, however, when the authorized domain encompasses more than one physical location. A consumer may have a home in Connecticut and an office in New York. The person may also have a vacation home in Colorado. If the consumer's devices in all these locations share the same identifier, then content can be freely shared between these devices. However, some content providers wish to impose geographical usage restrictions that cannot be implemented with such a system.

For example, a New York Yankees baseball game may be available to digital cable subscribers in Colorado, but be blacked-out from cable subscribers in the metro-New York market. The hypothetical consumer with a vacation home in Colorado may obtain the Colorado transmission, and then forward it, e.g., by a TCP/IP internet link, to her home in Connecticut, and view it there. Since the Connecticut device has the same domain identifier as the Colorado device, such sharing is freely permitted, although it violates the geographical usage restrictions that the content owner wishes to impose.

Another approach is the Content Protection System Architecture (CPSA)—a combination of technologies and policies proposed by Intel, IBM, Matsushita and Toshiba (the “4C Group”). Content Management Information (CMI) is specified for CPSA content, and is enforced by authorization protocols to ensure that any device to which the content is shared will reliably manage the content according to such management information. CMI may include copy control information (CCI, e.g., “freely copy,” “copy once,” “copy no more” and “never copy”), APS trigger bits (specifying protection to be applied to analog outputs), as well as other management information.

Sharing of content between devices under CPSA is generally performed in encrypted form, with the two devices undertaking specified handshaking so that the source device has confidence that the receiving device can be trusted. Encryption is used so that if the content is intercepted during its transmission (e.g., over a USB link), it will not be usable. DTCP is an exemplary protection technology used in CPSA systems to protect content during digital transmission between devices.

Generally, internet transmission of protected content is forbidden under CPSA. Rather, data exchange takes place across more trustworthy physical connections that have distance limitations. Thus, while the Yankees game cannot be relayed from Colorado to New York under CPSA, neither can any other CPSA-protected content—including that as to which the proprietor may have no geographical restriction.

CPSA has had difficulty adapting to home wireless networks that use Internet Protocol, such as WiFi (IEEE 802.11a, b or g), since they cannot distinguish the local area network (LAN; e.g. home) from a wide area network (WAN; e.g. vacation house and home). Router hops can be used as explained in pending application Ser. No. ______, filed Mar. 5, 2004, and entitled Content Identification, Personal Domain, Copyright Notification, Metadata and E-Commerce.

In accordance with one aspect of the present invention, various drawbacks of the above-referenced protection systems are overcome through use of firewalls. A firewall according to this exemplary embodiment examines flag bits in data packets to identify flag bits indicating that the data is protected by a protection scheme. On encountering such a flag bit, the firewall blocks external transmission of the data, thereby segmenting a network into geographical clusters.

In accordance with another aspect of the invention, packets of data are provided with identifiers of the content they contain, enhancing opportunities for management and use of such content.

The foregoing are just a few aspects of the invention detailed herein. Other aspects, features and advantages of the present invention will be more readily apparent from the following detailed description, which proceeds with reference to the accompanying drawings.

### BRIEF DESCRIPTION OF THE DRAWINGS

FIG. 1 is a flowchart illustrating one process according to the present invention.

FIG. 2 is a flowchart showing an illustrative sending device process.

FIG. 3 is a flowchart showing an illustrative sending or receiving firewall process.

### DETAILED DESCRIPTION

Content, including audio, video, images and text, is often packaged into small packets. This is the case for file systems, where the file is broken into blocks (which may be non-contiguous). This is also the case in networks. For example, in Internet Protocol (IP), content is broken into packets. If the content was originally identified, either with embedded data—such as digital watermarks, header data, or with linked data—such as with XML or URI, the breaking into packets commonly causes the identification to be lost.

One solution is to read or detect this content identifier and embed the content identifier into the header of the small packets. For example, the content ID may consist of 32 bits and be included in the header of an IP packet. Similarly, the same 32 bits could be saved in the header of a file block in a storage medium—as opposed to in the file table or in over-arching information linked to files, such as Windows Future System (WinFS http://msdn.microsoft.com/Longhorn/understanding/pillars/WinFS/default. aspx).

The header data in the packet may also include content type, forensic ID and copy control information (CCI). In an illustrative arrangement, content type may be two bits, where 0=text, 1=image, 2=video, and 3=audio. Forensic ID may be 32 bits and represent the recipient, such as the account ID of the person whom bought the content. The CCI may be as simple as 0=copy never, 1=copy once, 2=copy no more, 3=copy freely; may have multiple layers—such as for copy once and copy no more; and/or may have extended copy control bits as defined by the Motion Picture Association of America (MPAA).

Such identification data in the packet can be used for security, e.g., filtering content at firewalls, or for linking content to rights information—all without needing to recreate the whole content file and retrieve the identifier.

As the digital distribution of content to grow, it is critical for a consumer to easily access digital content while the content remains secure from massive piracy by the typical consumer (a.k.a. keep honest people honest). It is desirable for this market to grow due to the decreased distribution costs and potentially simple consumer usage models, such as video on demand or home audio jukeboxes with complete music collections.

Compliant Domain and Geographic Groups

In a representative system, the Compliant Domain (CD) (a.k.a. personal domain (PD) and personal home network and authorized domain) includes all of the equipment owned by a family that can share content according to a set of compliance rules. The Compliant Domain may be divided into Geographical Groups (GG) of compliant devices, such as organized by a group of devices within each home of the user. The goal is to allow users to easily access content within their home, and share between their homes if allowed based upon geographical constraints, but not to allow the content to be illegitimately shared between Compliant Domains. For example, if a movie is purchased, the purchaser should be able to easily transfer content within their Compliant Domain—potentially between a main and vacation home, but not give the movie to a friend to repeatedly watch in the friend's Compliant Domain (i.e. home). In another example, if a sporting event is broadcast, the recipient should be able to watch that event at any time within a Geographical Group of devices within their home, but not outside that Geographical Group for at least a certain amount of time restriction—even if the devices outside that Geographical Group are part of the Compliant Domain.

Typically, a Compliant Domain includes one, two or more Geographic Groups. In contrast, a Geographic Group generally is associated with only a single Compliant Domain.

The Geographical Groups will usually be inter-connected with Internet (TCP/IP) connections. Since such connections can enable access by anyone to the equipment within this Geographical Group, security must be included to allow the Geographical Group to access the Internet but not enable unknown users of the Internet to access the owner's equipment. This security is typically provided by a firewall, e.g., inside the home router.

In addition, devices from within a Geographical Group may be connected with a wireless connection, such as 802.11b (a.k.a. WiFi) or BlueTooth. This wireless connection is usually secured (e.g., by Wireless Encryption Protocol) so that neighbors and people passing by this home cannot access equipment within this home. The wireless access point (WAP)—which also usually serves as the router so that several devices can connect to one WAP—typically provides this security (as well as firewall functionality).

IP Packets

Devices within a TCP/IP network communicate using methods based on IP packets. An IP packet header contains the address where the packet is directed, and is usually about 512 bytes. The header may also contain an origination address, as well as other administrative data. The body of an IP packet can include any data, such as a piece of encrypted content for an image, song or video. Typically, a piece of content is broken into numerous IP packets, and each can take a different path to the destination. As such, combining the IP packets on any system other than the sending or receiving device is complex, and the more IP hops away from the sending or receiving device, the more challenging this becomes.

The foregoing is necessarily a brief summary of IP network technology. Those skilled in the art are understood to fully understand IP packet technology.

Problems

In order to share content within a Compliant Domain, but not between Geographic Groups, devices need to identify their location. This can be accomplished through use of Global Positioning System (GPS) equipment. However, the costs of such devices is prohibitive for broad deployment. Alternatively, some geographical information can be inferred from IP addresses. However, such approaches can be easily circumvented, e.g., by tunneling, spoofing, or mirroring. In addition, it is administratively and logistically difficult to manage geographical locations—as demonstrated with the failure of DVD regional codes.

In accordance with one aspect of the present invention, a WAP, router, and/or firewall serves to enforce certain content management policies, such as geographical restrictions on data sharing. An example of a device serving WAP, router, and firewall functions is the Linksys EtherFast® Wireless AP+Cable/DSL Router w/4-Port Switch (Linksys model number BEFW11S4; hereafter simply “the firewall”).

A difficulty with relying on the firewall to enforce content management policies is that it may require the firewall to re-assemble packets prior to taking any action. For example, if a digital watermark is used to convey certain content management instructions, the content may need to reassembled from the component packets (and decrypted if encrypted) before the watermark can be decoded and the management policy applied.

Watermarks are beneficial security features because they allow consumers to view content on legacy and existing devices, while compliant systems can respect security rules conveyed in the watermark payload. A watermark may carry basic information such as whether the content can be copied or moved outside a Compliant Domain or Geographical Group. Additionally or alternatively, a watermark may simply identify the content (e.g., using a Content ID) and a remote database can be consulted to determine usage rules, billing information, and enhanced metadata corresponding to that content ID.

Again, however, re-assembling packets, decrypting content, and detecting watermarks all entail computational overhead, and consequently impact expense of the firewall.

In accordance with an aspect of the present invention, intelligence information is added to the header of the IP packets, enabling the firewall to determine if that packet alone—without requiring other packets from the same content, and without processing the data within the packet—can be forwarded and/or if billing information should be applied. FIG. 1 shows an overview of such a process. As shown in box 100, a sending device determines from the nature of the content the intelligence header data that should be used, and places such intelligence header data in the numerous IP packets containing that content (i.e. related IP packets). The intelligence information can be obtained from the header of the content or a watermark within the content, and included in each IP packet related to that content. As shown in box 110, a sending firewall interprets the intelligent header data of the IP packet and decides whether or not to send the IP packet. As shown in box 120, a receiving firewall interprets the intelligent header data of the IP packet and decides whether or not to accept the IP packet.

Identifiable Content Packets

In a simple embodiment, when a packet of data is made from content, the content is checked for content identification, such as a digital watermark, fingerprint or header data (as discussed herein). If found, such a content ID (e.g., 32 bits) is placed in the header of the packet of data. (The content ID need not exactly duplicate the found identifier; it can be modified or created independently. The ID can identify the content by a classification category, such as audio in MP3 format, or a television broadcast captured by a personal video recorder—each of which may be associated with a particular class identifier, or it can more particularly or uniquely identify the content.)

The packet may be an Internet Protocol (IP) packet where the header also includes destination IP addresses. Alternatively, the packet may be a file system block stored on a hard drive or other storage medium, where the content ID is saved in a file system file allocation table or in the block of data itself (e.g., as the first 32 bits).

When this packet is acted upon, the content ID is read and corresponding information may be determined via a lookup in a linked database. The database may include rights, possibly using MPEG-21 REL (ISO/IEC 21000-5—Rights Expression Language, the specification of which is available at http://xml.coverpages.org/MPEG-21-REL-WD-200212.pdf and incorporated herein by reference). These rights may cause the action to be stopped. For example, the packet could be a block of a file and the action could be a file copy, and the associated rights may specify that the content is not allowed to be copied but only moved. (The restricted action (e.g., copy) may be permitted provided an appropriate fee is paid, such as via micro-payments transacted using operating system functionality.)

The content ID may be encrypted, using symmetric or public key encryption. In addition or alternatively, the packet header may contain a digital signature to authenticate that the content ID has not been changed.

The packet header may also contain content type and a forensic ID. The forensic ID can be used to track an IP packet to the original legitimate recipient, independent of its current path on the Internet.

Geographical Content Management Details

Intelligent IP Packets

The intelligence information included in the IP packet header can be of myriad types. One class may relate to geographic restrictions. For example, the intelligence information may comprise either or both of the following types:
Local control: this data can specify, e.g., whether the content can be moved outside the Compliant Domain, and whether the content can be moved outside the Geographical Group;
Identification: this data can identify the content, its type, the recipient's address and/or the recipient's Geographical Group (with associated usage rules and billing information being stored in a remote database).

Both types can be used, where the identification information has priority over the local control information, and the local control information is used when identification information is not included, or where the system is not intelligent enough to interpret the identification information—such as a firewall that cannot interpret a remote address. (Note that the firewall should always be able to access the remote database since it has access to the Internet and local network.)

There may also be a digital signature of the additional information such that the firewall can check the authenticity of the header data. The digital signature includes a hash, such as MD5, of the header data, and private key encryption of that hash. The digital signature can be locked to the IP packet by including the address data in the hash or combining the hash with a hash of the packet data, and then encrypting this combined hash. Such processing prevents someone from changing the header data and the appended hash. The combination of the hash of the intelligence information and data or address stops someone from switching headers between packets. (Such technology is further detailed in copending application Ser. No. 09/404,291, filed Sep. 23, 1999, the disclosure of which is incorporated by reference.)

An example of the additional information is the following:

| Local | Local | | | | |
|---|---|---|---|---|---|
| Control | Control | | | | |
| for | for | | | Recipient's | Recipient's |
| Compliant | Geographical | | | Compliant | Geographical |
| Domain | Groups | Content | Content | Domain ID | Group ID |
| (LC-CD) | (LC-GG) | Type | ID | (CD ID) | (GG ID) |
| 2 bits | 1 bit | 3 bits | 32 bits | 32 bits | 24 bits |

Naturally, not all of these fields need to be included.

The LC-Compliant Domain 2 bits can signal policies such as copy freely, copy never, copy once, and copy no more between Compliant Domains. The LC-Geographic Group contains a bit signifying whether copying outside the Geographic Group is permitted. The Content Type of 3 bits can signal whether the content represents image, audio or video, and whether the content is to be locked (restricted) to the Compliant Domain. The Content ID and Recipient's Compliant Domain ID can uniquely identify 4 billion IDs, and the Recipient's Geographic Group ID can uniquely identify 16,384 geographical locations in the world. (Again, the foregoing is illustrative only; actual implementations are expected to be tailored to particular system requirements.)

A remote database can contain usage and billing information about the content and can be associated with such content using the Content ID. The usage information may specify how long the content must remain within a Geographic Group and/or a Compliant Domain. The Recipient's Compliant Domain ID and Geographic Group ID can be used by the router to determine if it can leave or be accepted by the firewall, as described further below.

Several options described below do not require that the packet header include a Compliant Domain ID. Others don't require a Geographic Group ID. If implementation options are chosen that don't require either ID, the IP packet header data consists of only 38 bits. In addition, worldwide geographic locations do not need to be defined. Moreover, if only a local control scenario is chosen, the additional IP packet header data may consist of only 6 bits.

Sending Device

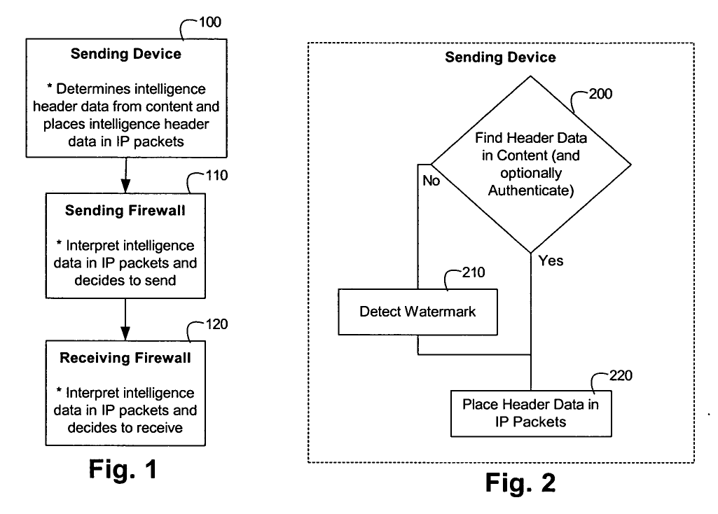

As is familiar to those skilled in the art, the creation of IP packets occurs at the sending device, such as a PC or set-top box (STB), as illustrated by FIG. 2. The sending device typically has sufficient processing resources—as well as access to the content, decryption engine, watermark detection, and remote database—so that it can easily (and without much additional cost) calculate and add intelligence information and digital signature to the IP packet header.

As shown in box 200, the sending device may check the header of content for the local control and identification information, optimally authenticate that this information is accurate and then, as shown in box 220, append it to each IP packet header related to this content. If the header information is authenticated in the content with the same, potentially standard, method as used in the IP packet, the header information from the content can be transferred to the header of each IP packet related to that content.

This header information in the content may be authenticated by a digital signature of the header information, potentially locked to the content as described in copending application Ser. No. 09/404,291. The header information may be contained within the content encryption package, too, in which it is automatically assumed to be authenticated. In other words, with proper encryption, if a pirate can change the header information, he/she can remove the content from the encryption package.

As shown in box 210, if the header information is not available or not authenticated, the sending device can check the content for a watermark. If a watermark exists within the content, it can be detected and its information can be included in the header of IP packets related to that content. The watermark can contain local control and/or identification information, which, as shown in box 220, is appended in the IP packets' headers. The watermark is usually inherently authenticated since it is embedded and detected with a secret key. The watermark payload can be authenticated with a digital signature (as described above) if a public watermarking key and protocol are used. In addition, the future may provide public/private key watermarking which is inherently authentic.

(Header data is checked before a watermark because it is assumed that header data is quicker to read and unauthenticated. However, if this is untrue, or for other reasons, this order can be switched.)

Firewall

The role of a firewall can be met by a variety of devices, including a wireless access point, a router, and a firewall (or combination thereof). The firewall can consist of a sending or receiving firewall, where the receiving firewall is adding a security layer to the sending firewall, especially important during the transition period while all firewalls are not compliant.

The firewall can cache the remote database entries referred to below to speed subsequent packet analysis since it is likely that numerous IP packets will be related to a piece of content. The remote database can be stored on the local network or Internet, or intelligently split between the two, as described in published applications U.S. 2002-0186844 and U.S. 2002-0162118, both incorporated by reference.

Such a firewall system is efficient in that it only needs to check header information for local control. For identification systems, the firewall needs to access a remote database and, optimally, cache information, both of which are relatively simple operations and should not drastically increase the cost of the firewall.

Sending Firewall

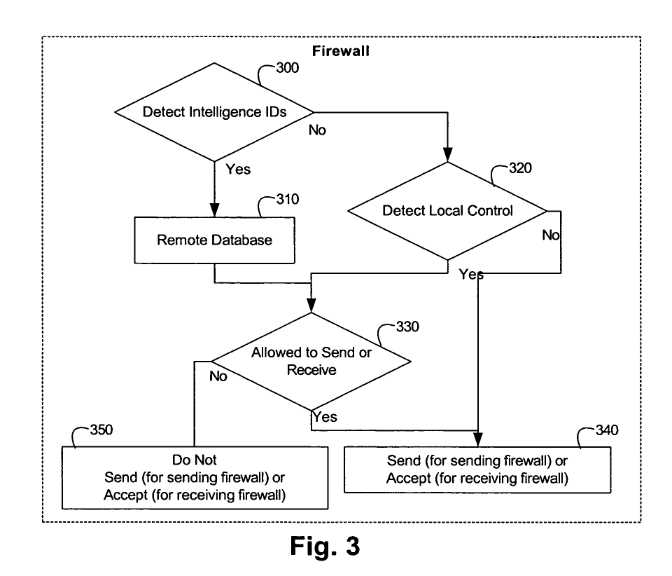

As shown in FIG. 3, the sending firewall process can include the following actions. As shown in box 300, the sending firewall looks for a content ID. If the content ID found, the firewall connects to a remote database (box 310) and determines if this content can be sent to another Compliant Domain or Geographic Group (within the same Compliant Domain), and if a charge is applicable (box 330).

If the IP packet can be sent to another Compliant Domain or Geographic Group, the firewall sends the transmission onwards (box 340), instituting a fee payment if required (e.g., by communicating with the remote database or another remote server). The remote database may ensure the charge is paid, either with cyber-cash, via a subscription account, or any other applicable method.

If the IP packet cannot be sent to another Compliant Domain, but can be sent to another Geographic Group within the same Compliant Domain, the firewall has several options.

In a first option, the sending firewall can check that the recipient IP address specified in the packet is within the Compliant Domain ID, e.g., by reference to the remote database. If so, it sends the packet (box 340). If not, it does not send the packet (box 350). This option generally requires the database entry for the content ID to contain firewall IP addresses for each Geographic Group, thus requiring a registration authority. For this option, the Compliant Domain ID and Geographic Group ID are not required in the IP packet header.

In a second option, this action can be skipped for the sending firewall and applied only at the receiving firewall. The receiving firewall should make sure its Compliant Domain ID matches that of the IP packet header.

In a third option, this action can be skipped if the content type indicates the content is locked to the Compliant Domain. As such, the underlying security system stops content from being moved outside the Compliant Domain. Once again, the Compliant Domain ID and Geographic Group ID are not required.

In any of these options (and others) a charge may apply, e.g., as determined from the remote database, and can be handled as the particular application warrants.

If the content cannot be copied outside the Compliant Domain or Geographic Group, the firewall also has several options.

In one option, the sending firewall checks that the recipient IP address in the packet is within the Compliant Domain ID, e.g., via the remote database. If so, it sends the packet (box 340). If not, it does not send the packet (box 350). This option generally requires the database entry for the content ID to contain firewall IP addresses for each Geographic Group, thus requiring a registration authority. For this option, the Compliant Domain ID and Geographic Group ID are not required in the IP packet header protocol.

In a second option, this action can be skipped for the sending firewall and applied at the receiving firewall. The receiving firewall should make sure its Compliant Domain ID and Geographic Group ID match that of the Compliant Domain ID and Geographic Group ID IP packet header, as fully described below.

An a third option, the firewall assumes that no one has two homes within one Geographic Group and blocks the packet from being sent (box 350). For this option, the Geographic Group ID is never needed, and can be left out of the IP packet header protocol.

In addition, the remote database can be updated over time, or contain time sensitive data, such that for a week after receiving content, the content cannot be sent outside the receiving Geographic Group, and then changed at the end of the week. Similarly, the content ID database entry could be updated or contain time sensitive information that doesn't allow the content to be sent outside the recipient's Compliant Domain for 6 months. (The week and 6 month figures are illustrative only; in some situations these figures may be shortened to a few days or hours; in others, still longer time periods may be appropriate.)

If identification information is not included in the header data, or if the firewall is not intelligent enough to interpret identification information (e.g., interpreting data in the remote database), the local control information can be used by the sending firewall, as shown in box 320. The sending firewall looks at the LC-Geographic Group information, and if it states that the content cannot be copied (assuming then the LC-Compliant Domain is the same and not less restrictive), the sending firewall blocks the transmission, as shown in 350.

Otherwise, the sending firewall looks at the LC-Compliant Domain, and if it states the content cannot be copied via copy-no-more or copy-once states, but the LC-Geographic Group enables copying, the firewall has various options.

In one, the firewall determines if the destination IP address is within the same Compliant Domain and, if so, sends the IP packet (box 340) or, if not, does not send the IP packet (box 350).

In a second, the firewall determines if the content type states that the content is locked to the Compliant Domain. If so, the firewall sends the content (box 340) and lets the underlying security of the content make sure the content cannot be played outside the Compliant Domain.

In a third option, if the content type is not specified (since some or all fields may be optional), and the firewall cannot determine if the recipient's IP address is within the same Compliant Domain, the packet is not sent (box 350).

Otherwise, if the LC-Compliant Domain enables copying via copy-freely, the firewall sends the IP packet (box 340). If the LC-Compliant Domain is specified to be copy-once, the firewall can send the packet (box 340) if it can update a remote database stating that the content has been copied. If the firewall cannot update a remote database, it does not send the content (box 350).

Receiving Firewall

As shown in FIG. 3, the receiving firewall process can include the following actions. (Depending upon the options described above chosen for the system, it can be optional for the receiving firewall to performs these actions, but optimal during the transition when some sending firewalls don't have the ability to check for packet intelligence.)

As shown in box 300, the receiving firewall looks for a content ID. If the content ID found, the firewall connects to a remote database (box 310) and determines if this content can be received by another Compliant Domain or Geographic Group (within the same Compliant Domain), and if a charge is applicable (box 330).

If the IP packet can be received by another Compliant Domain or Geographic Group, the firewall accepts the transmission (box 340), updating the remote database with the correct charge, if appropriate—noting that the remote database determines if the sender and/or recipient is charged, and how much for each. The remote database makes sure the charge is paid, either with cyber-cash, via a subscription account, or any other applicable method.

If the IP packet cannot be sent to another Compliant Domain, but only within the same Compliant Domain to another Geographic Group, the receiving firewall has several options.

In one option, the receiving firewall duplicates the check by the sending firewall and determines if the recipient IP address in the packet is within the Compliant Domain ID, e.g., by checking the remote database. If so, it accepts the packet (box 340). If not, it does not send the packet (box 350). This option generally requires the database entry for the content ID to contain firewall IP addresses for each Geographic Group, thus, requiring a registration authority. For this option, the Compliant Domain ID and Geographic Group ID are not required in the IP packet header.

In a second option, as described above, the receiving firewall must make sure its Compliant Domain ID matches that of the IP packet header.

In a third option, as described above, this action can be skipped if the content type states the content is locked to the Compliant Domain. As such, the underlying security system stops content from being moved outside the Compliant Domain. Once again, the Compliant Domain ID and Geographic Group ID are not required.

In any of these options a charge may apply, as determined from the remote database and can be handled appropriately, e.g., as described above.

If the content cannot be copied outside the Compliant Domain or Geographic Group, the receiving firewall also has various options.

In one option, the receiving firewall duplicates the check of the sending firewall and determines if the recipient IP address in the packet is within the Compliant Domain ID, e.g., by reference to the remote database. If so, it sends the packet (box 340). If not, it does not send the packet (box 350). This option generally requires the database entry for the content ID to contain firewall IP addresses for each Geographic Group, thus, requiring a registration authority. For this option, the Compliant Domain ID and Geographic Group ID are not required in the IP packet header protocol.

In another option, as described above, the receiving firewall ensures that its Compliant Domain ID and Geographic Group ID match that of the Compliant Domain ID and Geographic Group ID IP packet header.

In a third option, the receiving firewall assumes that no one has two homes within one Geographic Group and blocks the packet from being sent (box 350). For this option, the Geographic Group ID is never needed, and can be left out of the IP packet header protocol.

Again, the remote database can be updated over time, as described above.

If identification information is not included in the header, or if the receiving firewall is not intelligent enough to interpret identification information, the local control information can be used by the receiving firewall, as shown in box 320. The receiving firewall looks at the LC-Geographic Group, and if it signals that the content cannot be copied (assuming then the LC-Compliant Domain is the same and not less restrictive), the receiving firewall blocks the transmission, as shown in 350.

Otherwise, the receiving firewall looks at the LC-Compliant Domain, and if it indicates that the content cannot be copied via copy-no-more or copy-once states, but the LC-Geographic Group enables copying, the firewall has several options.

In one, the receiving firewall double checks the sending firewall and determines if the IP address is within the same Compliant Domain. If so, it accepts the IP packet (box 340), else, it does not accept the IP packet (box 350).

In another option, the receiving firewall determines if the content type states that the content is locked to the Compliant Domain. If so, the firewall accepts the content (box 340) and lets the underlying security of the content make sure the content cannot be played outside the Compliant Domain.

In a third option, if the content type is not specified, and the receiving firewall cannot determine if the recipient's IP address is within the same Compliant Domain, the packet is not accepted (box 350).

Otherwise, if the LC-Compliant Domain enables copying via copy-freely, the receiving firewall accepts the IP packet (box 340). If the LC-Compliant Domain is copy once, the receiving firewall can accept the packet (box 340) if it can update a remote database stating that the content has been copied. If the firewall cannot update a remote database, it does not accept the content (box 350).

Alternatives

Having described and illustrated the principles of my technology with reference to numerous embodiments and variations thereof, it should be apparent that the technology can be modified in arrangement and detail without departing from such principles.

For example, the usage and billing rights information may form part of the content, such as part of the header data or part of the packet body, using a protocol such as ContentGuard's extensible Rights Markup Language (XrML). Or the XrML information could be separate and the remote database provides a uniform resource locator (URL) descriptor for that file.

Repeated reference was made to a remote database that includes various information and helps perform various functions (e.g., fee payments). It will be recognized that alternative implementations do not require such a remote database. Certain information may be stored locally, or may be transmitted with (or inferred from) the content.

Those skilled in the art will recognize that a hardware firewall is of well-known construction, and typically comprises a processor linked to memory, as well as input and output ports. The memory commonly contains program instructions to implement desired functionality—such as that detailed above.

To provide a comprehensive disclosure without unduly lengthening this specification, applicant incorporates by reference copending application Ser. No. ______, filed Mar. 5, 2004, and entitled Content Identification, Personal Domain, Copyright Notification, Metadata and E-Commerce.

1. In a method of enforcing geographical restrictions on content redistribution in a TCP/IP network, an improvement comprising defining a geographical boundary across which certain content does not pass, wherein said boundary is defined—at least in part—by a hardware firewall device.

2. The method of claim 1 that includes determining whether an IP packet should be regarded as conveying content that should not cross said boundary, by reference to flag bits included in the header of said packet.

3. The method of claim 2 wherein said flag bits are related to the payload of a watermark in the content.

4. In a method of data processing that includes forming an IP packet having header data and body data, wherein the header data includes a first destination address, an improvement comprising forming said header data to additionally include additional data specifying whether it is permissible to send a copy of data in the packet to a second destination address.

5. The method of claim 4 wherein the additional data has at least two states, respectively indicating:
(a) it is not permissible to send a copy of data in the packet to any second destination address; or
(b) it is not permissible to send a copy of data in the packet to any second destination address except to a second destination address within a domain that also includes the first destination address.

6. The method of claim 5 wherein said domain comprises networked devices associated with a single family.

7. The method of claim 4 wherein a device associated with the first destination address has a first physical location and a device associated with the second destination address has a second physical location, and the additional data includes a field signaling that copying of data in said packet to said second destination address should be:
(a) permitted if the second physical location is physically proximate to the first physical location; and
(b) prohibited if the second physical location is physically remote from the first physical location.

8. The method of claim 7 wherein the first and second destination addresses are within a common domain.

9. The method of claim 7 wherein the first and second destination addresses both correspond to network devices associated with a single family.

10. The method of claim 4 wherein said additional data is related to the payload of a watermark encoded in the body data.

11. In a method of data processing that includes receiving an IP packet having header data and body data, wherein the header data includes a first destination address, the first destination address corresponding to a device at a first physical location proximate to where said method is practiced, an improvement comprising interpreting additional data in the header of said packet as specifying whether it is permissible to send a copy of data in the packet to a second destination address.

12. The method of claim 11 wherein:
(a) if the additional data has a first state, prohibiting transmission of a copy of data in the packet to any second destination address; and
(b) if the additional data has a second state, prohibiting transmission of a copy of data in the packet to any second destination address other than a second destination address within a domain that also includes the first destination address.

13. The method of claim 12, wherein said domain comprises networked devices associated with a single family.

14. The method of claim 11 wherein a device associated with the second destination address has a second physical location and wherein:
(a) if the second physical location is physically proximate to the first physical location, permitting copying of data in said packet to the second destination address; and
(b) if the second physical location is physically remote from the first physical location, prohibiting copying of data in said packet to the second destination address.

15. The method of claim 14 wherein the first and second destination addresses are within a common domain.

16. The method of claim 14 wherein the first and second destination addresses both correspond to network devices associated with a single family.

17. The method of claim 14 wherein the method includes determining whether the second physical location is physically remote from the first physically location by reference to whether the second destination address is served by a common firewall with the first destination address.

18. The method of claim 11 wherein said additional data is related to the payload of a watermark encoded in the body data.

19. A method wherein content is divided and collectively represented by plural packets of data, each packet having first and second portions, the first portion of each packet including a divided part of the content, the method including obtaining an identifier of said content, and including said content identifier in the second portion of each packet.

20. The method of claim 19 wherein said obtaining includes examining a previous representation of said content that has an identifier associated therewith.

21. The method of claim 19 wherein the packets comprise IP packets, each having a body portion as said first portion, and a header portion as said second portion, said header portion including address information in addition to said content identifier.

22. The method of claim 19 wherein the packets comprise non-contiguous blocks of data in a storage medium, said blocks being associated together by a table of file allocation data.

23. The method of claim 22 wherein each of said non-contiguous blocks includes a content identifier, but data in said table does not.

24. The method of claim 19 that further includes reading the content identifier from the second portion of one of said packets to identify content represented by data in the first portion.
